(19) United States
(12) Patent Application Publication
(10) Pub. No.: US 2007/0229235 A1
(43) Pub. Date: Oct. 4, 2007

(54) VEHICLE-MOUNTED SOUNDING DEVICE

(75) Inventor: Yoshiyasu HIRAI, Iwata-shi (JP)

Correspondence Address: ROSSI, KIMMS & McDOWELL LLP., P.O. BOX 826, ASHBURN, VA, 20146-0826, US

(73) Assignee: YAMAHA CORPORATION, Hamamatsu-shi (JP)

(21) Appl. No.: 11/691,562

(22) Filed: Mar. 27, 2007

(30) Foreign Application Priority Data
Mar. 30, 2006 (JP) 2006-093653
Jun. 20, 2006 (JP) 2006-169895

(51) Int. Cl. B60Q 1/00; G08B 1/00; G08B 25/08

(52) U.S. Cl. 340/425.5; 340/531; 340/692

(57) ABSTRACT

There are provided sound collector for collecting a sound emitted by a vehicle and converting the sound to a first electric signal, signal processor for applying acoustic signal processing to the first electric signal and outputting a second electric signal, and sound emitter for inputting and emitting the second electric signal.

### BACKGROUND OF THE INVENTION

The present invention relates to a vehicle-mounted sounding device for emitting a warning sound for a vehicle.

Related art klaxon (horn) sound for an automobile used to be a mechanical sound without a quality appearance. It has been a general practice to replace a klaxon horn with a commercial product in order to change the tone quality of the klaxon.

Another technique disclosed in JP-A-7-205720 delivers an audio guide such as “turning to left” or “reversing” in order to alert the people around.

However, the sound of a klaxon is a warning sound and it is not permitted to radically change its tone quality. This limits the quality appearance given to the klaxon sound. As a matter of fact, a klaxon must be emitted when the driver has pressed a klaxon switch.

Electric vehicles and hybrid vehicles recently in widespread use generally emit a smaller running noise. Pedestrians have difficulty in noticing the traveling state of such a vehicle especially in case they are traveling at low speed. To solve this problem, devices that use the above audio guide have been provided. While this approach is effective in solving the problem, indicating the presence of a vehicle by uttering a voice such as “starting” or “traveling” by way of an audio guide sounds unnatural. Emitting the exiting klaxon sound alone is not enough for a pedestrian to intuitively grasp the traveling state of a vehicle including the sense of the speed of the vehicle.

### SUMMARY OF THE INVENTION

The invention has been accomplished in view of the aforementioned circumstances. An object of the invention is to give a quality appearance to the tone quality of a klaxon while maintaining the character as a warning sound. Another object is to notify the people around of the approach of a vehicle by emitting a running noise of a natural tone quality from a vehicle with a small running noise such as an electric vehicle.

In order to solve the problem, the present invention is characterized by having the following arrangements.
(1) A vehicle-mounted sounding device comprising:
   a sound collector that collects a sound emitted by a vehicle and converts the sound to a first electric signal;
   a signal processor that applies acoustic signal processing to the first electric signal and outputs a second electric signal; and
   a sound emitter that inputs the second electric signal and emits a sound based on the second electric signal.
(2) The vehicle-mounted sounding device according to (1) further comprising:
   a switch operation detector that detects switch operation related to a klaxon of a vehicle; and
   a sound generator that generates a third electric signal for sounding and outputs the third electric signal to the sound emitter when the switch operation detector detects the switch operation,
   wherein the sound emitter inputs the third electric signal and emits a sound based on the third electric signal.
(3) The vehicle-mounted sounding device according to (1) further comprising:
   a switch operation detector that detects switch operation related to a traveling of a vehicle; and
   sound generator that generates a third electric signal for sounding and outputs the third electric signal to the sound emitter when the switch operation detector detects the switch operation,
   wherein the sound emitter inputs the third electric signal and emits a sound based on the third electric signal.
(4) The vehicle-mounted sounding device according to (2) further comprising:
   a signal intensity detector that detects intensity of the first electric signal; and
   an abnormal state detector that detects an abnormal state based on the detection result of the switch operation detector and the detection result of the signal intensity detector,
   wherein the sound generator outputs as the third electric signal an electric signal that represents a warning sound when the abnormal state detector detects the abnormal state.
(5) The vehicle-mounted sounding device according to (3) further comprising:
   a signal intensity detector that detects intensity of the first electric signal;
   a speed detector that detects a traveling speed of the vehicle;
   a first abnormal state detector that detects an abnormal state based on the detection result of the switch operation detector and the detection result of the signal intensity detector; and
   a second abnormal state detector that detects an abnormal state based on the detection result of the speed detector and the detection result of the signal intensity detector,
   wherein the sound generator outputs as the third electric signal an electric signal that represents a warning sound when the first abnormal state detector or the second abnormal state detector detects the abnormal state.
(6) The vehicle-mounted sounding device according to (1), wherein
   the sound generator comprises an amplifier for amplifying the third electric signal and a plurality of speakers driven by the amplifier, and
   the amplifier selectively drives a specific speaker corresponding to a travel direction of a vehicle.

According to the invention, it is possible to give a quality appearance to the tone quality of a klaxon while maintaining the character as a warning sound. With a vehicle emitting a small running noise such as an electric vehicle, it is possible to add a running noise of a natural tone quality from the vehicle to notify the people around the approach of the vehicle.

### BRIEF DESCRIPTION OF THE DRAWINGS

FIG. 1 shows an overall configuration of a vehicle-mounted sounding device that changes the tone quality of a klaxon according to an embodiment of the invention.

FIG. 2 shows an overall configuration of a vehicle-mounted sounding device that changes the running noise of an automobile according to an embodiment of the invention.

### DETAILED DESCRIPTION OF PREFERRED EMBODIMENTS

### First Embodiment

The first embodiment of the invention will be described referring to drawings.

While a vehicle-mounted sounding device according to this embodiment is applicable to a general vehicle including an automobile, a motorized bicycle, and a light vehicle, this embodiment uses an automobile as an example.

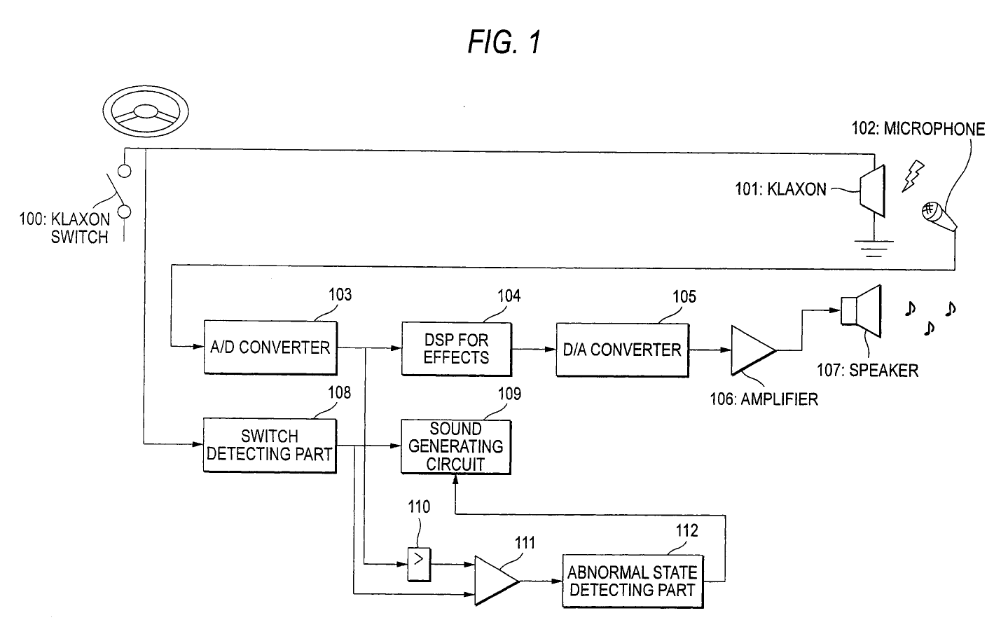

FIG. 1 shows an overall configuration of a vehicle-mounted sounding device according to the first embodiment. The vehicle-mounted sounding device collects the sound of klaxon (horn), processes the sound and emits the resulting sound. As shown in FIG. 1, the vehicle-mounted sounding device comprises a klaxon switch 100, a klaxon (horn) 101, a microphone 102, an A/D converter 103, a DSP (Digital Signal Processor) 104 for effects, a D/A converter 105, an amplifier 106, a speaker 107, a switch detecting part 108, a sound generating circuit 109, a sound pressure detector 110, a comparator 111, and an abnormal state detecting part 112.

The klaxon switch 100 is connected to the klaxon 101 and operated by a driver as a user of the vehicle-mounted sounding device to sound the klaxon 101. The klaxon 101 emits a warning sound in accordance with the operation of the klaxon switch 100. An alarm device including the klaxon switch 100 and the klaxon 101 is a type of safety device that has been provided on an automobile and is used without modification in this invention.

The microphone 102 is arranged in a position where it is possible to efficiently collect a warning sound emitted by the klaxon 101. The microphone 102 converts the warning sound to an electric signal of an analog quantity. The microphone 102 functions as a sound collector in this invention.

The A/D converter 103 converts an analog electric signal as the output signal of the microphone 102 to a digital signal. The DSP 104 for effects is connected to the output of the A/D converter 103. The DSP 104 for effects applies predetermined acoustic signal processing to the digital signal as the output signal of the A/D converter 103 to process the warning sound of the klaxon into a reverberant sound or a harmonic. The DSP 104 for effects functions as a signal processor in the invention.

The D/A converter 105 is connected to the output of the DSP 104 for effects and the output of a sound generating circuit 109 described later. The D/A converter 105 converts digital signals as output signals of the DSP 104 for effects and the sound generating circuit 109 to analog electric signals and outputs the same. The amplifier 106 is connected to the output of the D/A converter 105. The amplifier 106 amplifies the analog electric signal output from the D/A converter 105. The speaker 107 is connected to the output of the amplifier 106. The speaker 107 converts the analog electric signal output from the amplifier 106 to a sound and emits the sound. The amplifier 106 and the speaker 107 function as a sound emitter in the invention.

The switch detecting part 108 is connected to the klaxon switch 100. The switch detecting part 108 detects the operation of the klaxon switch 100. The switch detecting part 108 functions as a switch operation detector in the invention.

The sound generating circuit 109 is connected to the output of the switch detecting part 108. The sound generating circuit 109 synthesizes sounding signals and outputs the composite sounding signal as a digital signal.

The sound pressure detector 110 is connected to the output of the A/D converter 103. The sound pressure detector 110 detects the intensity of the output signal of the A/D converter 103 to determine whether a warning sound of a predetermined sound pressure or above is input to the microphone 102. The sound pressure detector 110 functions as a signal intensity detector in the invention.

The comparator 111 is connected to the outputs of the switch detecting part 108 and the sound pressure detector 110 and compares the output levels thereof to each other. The abnormal state detecting part 112 detects an abnormal state from the output signal of the comparator 111 and outputs an abnormal state detecting signal to the sound generating circuit 109. The comparator 111 and the abnormal state detecting part 112 function as an abnormal state detector in the invention.

Operation of the vehicle-mounted sounding device according to this embodiment will be detailed.

Operation of this embodiment is classified into three types: tone quality processing, sound generation and abnormal state monitoring.

When the driver of an automobile (user) operates the klaxon switch 100, the klaxon 101 operates to emit a warning sound. The process so far is emission of a warning sound by an ordinary klaxon.

(1) Tone Quality Processing

In coordination with the sounding of the klaxon, the tone quality processing takes place:

The microphone 102 collects the warning sound emitted by the klaxon 101 and converts the alarm to an electric signal (a first electric signal) of an analog quantity. The A/D converter 103 converts the analog signal to a digital signal and outputs the digital signal to the DSP 104 for effects. (harmony sound imparting feature)

The DSP 104 for effects applies acoustic signal processing to the digital signal input from the A/D converter 103 and processes the signal into a digital signal (second electric signal) representing a reverberant sound or a harmonic that may give audience a quality appearance. Available digital signal processing includes such processing as pitch change processing and processing using the “hamorun” feature of karaoke. The user may select predetermined acoustic signal processing. In this embodiment, the signal is processed into a digital signal representing a reverberant sound.

Next, the digital signal that has undergone acoustic signal processing is converted to an analog signal in the D/A converter 105. The amplifier 106 amplifies the analog signal and drives the speaker 107. The speaker 107 converts the analog signal to a sound and emits a reverberant sound.

The user may arbitrarily change the volume of the reverberant sound by adjusting the amplification degree of the amplifier 106.

Through the above process, an ordinary warning sound is emitted from the klaxon 101 while the warning sound is processed into a reverberant sound by this device and emitted from the speaker 107. A pedestrian around hears the warning sound emitted from the klaxon 101 and its reverberant sound and thus feels as though the warning sound emitted from the klaxon 101 includes the reverberant sound and enjoys a quality appearance in the tone quality of the warning sound from the klaxon.

(2) Sound Generation

The following sound generation takes place in parallel with the tone quality processing.

When the klaxon switch 100 is operated, the switch detecting part 108 detects the operation of the klaxon switch 100 and outputs a sounding start signal. When detecting the operation of the klaxon switch 100, the switch detecting part 108 emits a high-level signal (sounding start signal). When not detecting the operation of the klaxon switch 100, the switch detecting part 108 emits a low-level signal.

In case the sounding start signal is input, the sound generating circuit 109 generates a predetermined acoustic signal and outputs the acoustic signal as a digital signal (third electric signal). The sound generating circuit 109 has sound data previously stored therein data for generating multiple types of acoustic signals. The user may arbitrarily select the type of acoustic signal. As the sound data, various types of effect sounds are available on top of the reverberant sound. In this embodiment, it is assumed that sound data to represent an effect sound has been pre-selected.

The D/A converter 105 converts the digital signal of the sound data representing the effect sound to an analog signal. The amplifier 106 amplifies the analog signal of the effect sound and supplies the resulting signal to the speaker 107. The speaker 107 converts the amplified analog signal to a sound and emits an effect sound.

Through the tone quality processing and sound generation described above, a related art klaxon sound generated from the klaxon 101, the reverberant sound generated through acoustic signal processing on the klaxon sound, and the effect sound synthesized by the sound generating circuit 109 are emitted from the speaker 107. A pedestrian around hears the three types of sound for example as a soft sound with a quality appearance and reverberation including a tone quality desired by the user.

In case the DSP 104 for effects emits a harmonic having a frequency double that of the klaxon sound, a harmonic sound of one octave can be added to the related art klaxon sound.

(3) Abnormal State Monitoring

The following abnormal state monitoring takes place in parallel with the tone quality processing and sound generation.

The sound pressure detector 110 constantly monitors the intensity of the digital signal as the output of the A/D converter 103 and detects a sound pressure of a warning sound at a predetermined level or above input to the microphone 102. To be more precise, the sound pressure detector 110 outputs a high-level signal in case it has detected a sound pressure at a predetermined level or above while it outputs a low-level signal in case it has detected a sound pressure below a predetermined level. The output of the sound pressure detector 110 and the output of the switch detecting part 108 are respectively input to the comparator 111. The comparator 111 is configured by an exclusive OR circuit.

Assume that an abnormal state (a fault) has occurred where a sound pressure of a warning sound at a predetermined level or above is not detected due to a fault in the klaxon 101 or microphone 102 although the klaxon switch 100 is operated. In such a case, the output signal of the sound pressure detector 110 is driven Low while the output signal of the switch detecting part 108 is driven High.

Assume that an abnormal state (a fault) has occurred where a sound pressure of a warning sound at a predetermined level or above is detected due to a fault in the klaxon 101 or microphone 102 although the klaxon switch 100 is not operated. In such a case, the output signal of the sound pressure detector 110 is driven High while the output signal of the switch detecting part 108 is driven Low since the klaxon switch 100 is not operated.

Thus, under the two conditions, the output signal of the comparator 111 is driven High (a signal indicating an abnormal state). Receiving this signal, the abnormal state detecting part 112 detects an abnormal state and outputs an abnormal state detecting signal to the sound generating circuit 109. Using the abnormal state detecting signal as a trigger, the sound generating circuit 109 generates an alarm signal (third electric signal) for reporting an abnormal state (fault) and emits a warning sound from the speaker 107 thus notifying the user of the abnormal state in the device.

In normal operation, the output signal of the switch detecting part 108 has the same level as the output signal of the sound pressure detector 110. This drives the output signal of the comparator 111 Low and the abnormal state detecting part 112 that receives this signal does not output an abnormal state detecting signal to the sound generating circuit 109.

The Low or High level of a signal defined in this embodiment is not limited but the signal levels maybe exchanged as long as a similar function is provided.

According to the invention, it is possible to give a quality appearance of the auditory sense of a human to a warning sound emitted into the surroundings only by adding the vehicle-mounted sounding device without modifying an existing alarm device. It is also possible to provide a warning sound of a tone quality favored by the user while maintaining the character as a warning sound. Further, it is possible to provide the vehicle-mounted sounding device at a low cost.

### Second Embodiment

The second embodiment of the invention will be described referring to drawings.

While a vehicle-mounted sounding device according to this embodiment is applicable to a vehicle in general including an automobile, a motorcycle with a displacement of less than 50 cc, and a light vehicle, this embodiment uses an automobile as an example.

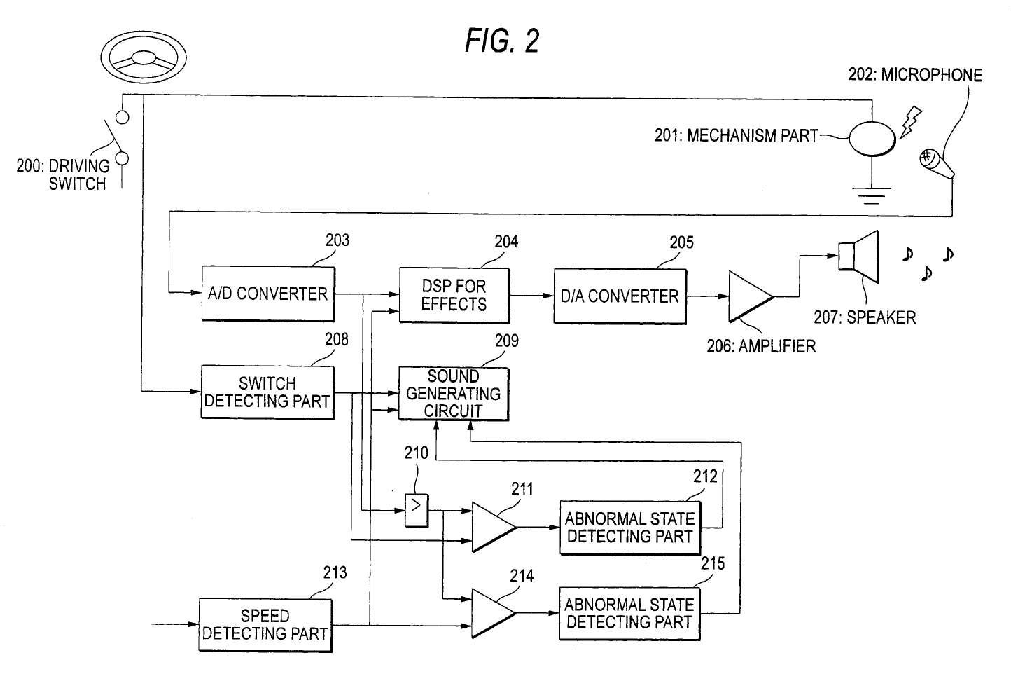

FIG. 2 shows an overall configuration of a vehicle-mounted sounding device according to the second embodiment. The vehicle-mounted sounding device collects the operation sounds (such as sounds of an engine, a motor and a mechanism part), processes the sounds and emits the resulting sound. As shown in FIG. 2, the vehicle-mounted sounding device comprises an operation switch (control switch) 200, a mechanism part (such as a motor) 201, a microphone 202 functioning as a pickup sensor, an A/D converter 203, a DSP (Digital Signal Processor) 204 for effects, a D/A converter 205, an amplifier 206, a speaker 207, a switch detecting part 208, a sound generating circuit 209, a sound pressure detector 210, a comparator 211, an abnormal state detecting part 212, a speed detecting part 213, a comparator 214, and an abnormal state detecting part 215.

The driving switch 200 is connected to the mechanism part 201. The driving switch 200 is operated by a driver as the user of the vehicle-mounted sounding device to start the engine or motor and perform other driving control. For example, the driving switch 200 may include a plurality of switches (not shown) such as a switch coordinated with direction signals operated to make a right turn or a left turn and a switch coordinated with selection of a reverse gear. The mechanism part 201 operates in accordance with the operation of the driving switch 200. The driving switch 200 and the mechanism part 201 have been provided on an automobile and are used without modification in this invention.

The microphone 202 is arranged in a position where it is possible to efficiently collect an operation noise emitted by the mechanism part 201. The microphone 202 converts the operation noise to an electric signal of an analog quantity. The microphone 202 functions as sound collector in this invention.

The A/D converter 203 converts an analog electric signal as the output signal of the microphone 202 to a digital signal. The DSP 204 for effects is connected to the output of the A/D converter 203. The DSP 204 for effects applies predetermined acoustic signal processing to the digital signal as the output signal of the A/D converter 203 to process the operation noise of the mechanism part into a sound close to that of an automobile or a sound offensive to the people around. The DSP 204 for effects functions as a signal processor in the invention.

The D/A converter 205 is connected to the output of the DSP 204 for effects and the output of a sound generating circuit 209 described later. The D/A converter 205 converts digital signals as output signals of the DSP 204 for effects and the sound generating circuit 209 to analog electric signals and outputs the same. The amplifier 206 is connected to the output of the D/A converter 205. The amplifier 206 amplifies the analog electric signal output from the D/A converter 205. The speaker 207 is connected to the output of the amplifier 206. The speaker 207 converts the analog electric signal output from the amplifier 206 to a sound and emits the sound. The amplifier 206 and the speaker 207 function as a sound emitter in the invention.

The switch detecting part 208 is connected to the driving switch 200. The switch detecting part 208 detects the operation of the driving switch 200. The switch detecting part 208 functions as switch operation detector in the invention.

The sound generating circuit 209 is connected to the output of the switch detecting part 208. The sound generating circuit 209 synthesizes sounding signals and outputs the composite sounding signal as a digital signal.

The sound pressure detector 210 is connected to the output of the A/D converter 203. The sound pressure detector 210 detects the intensity of the output signal of the A/D converter 203 to determine whether a warning sound of a predetermined sound pressure or above is input to the microphone 202. The sound pressure detector 210 functions as a signal intensity detector in the invention.

The comparator 211 is connected to the outputs of the switch detecting part 208 and the sound pressure detector 210 and compares the output levels thereof to each other. The abnormal state detecting part 212 detects an abnormal state from the output signal of the comparator 211 and outputs an abnormal state detecting signal to the sound generating circuit 209. The comparator 211 and the abnormal state detecting part 212 function as a first abnormal state detector in the invention.

The speed detecting part 213 is connected to a speedometer (not shown) and used to determine whether the speed of a vehicle is at a predetermined level or above. The speed detecting part 213 functions as a speed detector in the invention.

The comparators 214 is connected to the outputs of the speed detecting part 213 and the sound pressure detector 210 and compares the output levels thereof to each other. The abnormal state detecting part 215 detects an abnormal state from the output signal of the comparator 214 and outputs an abnormal state detecting signal to the sound generating circuit 209. The comparator 214 and the abnormal state detecting part 215 function as a second abnormal state detector in the invention.

Operation of the vehicle-mounted sounding device according to this embodiment will be detailed.

Operation of this embodiment is classified into four types: tone quality processing, voice generation, abnormal state monitoring 1 and abnormal state monitoring 2.

When the driver of an automobile (user) operates the driving switch 200, the mechanism part 201 operates to emit an operation noise. The process so far is operation in an ordinary automobile.

(1) Tone Quality Processing

In coordination with the sounding in the automobile, the tone quality processing takes place:

The microphone 202 collects the operation noise emitted by the mechanism part 201 and converts the noise to an electric signal (a first electric signal) of an analog quantity. The A/D converter 203 converts the analog signal to a digital signal and outputs the digital signal to the DSP 204 for effects.

The DSP 204 for effects applies acoustic signal processing to the digital signal input from the A/D converter 203 and processes the signal into a digital signal (second electric signal) representing a noise that causes the people around to imagine the travel of an actual automobile or an inoffensive noise.

Next, the digital signal that has undergone acoustic signal processing is converted to an analog signal in the D/A converter 205. The amplifier 206 amplifies the analog signal and drives the speaker 207. The speaker 207 converts the analog signal to a sound and emits a running noise.

The user may arbitrarily change the volume of the running noise by adjusting the amplification degree of the amplifier 206.

Through the above process, a small operation noise is emitted from the mechanism part 201 while the operation noise is processed into a running noise that mimics the travel of an automobile by way of this device, and amplified and emitted from the speaker 207. A pedestrian around is able to properly grasp the travel state of an automobile from the running noise emitted by the speaker 207 even though the operation noise emitted by the mechanism part 201 is small, and thus may intuitively imagine a situation of the approach of an automobile.

(2) Voice Generation

The following voice generation takes place in parallel with the tone quality processing.

When the driving switch 200 is operated, the switch detecting part 208 detects the operation of the mechanism part 201 and outputs a sounding start signal. When detecting the operation of the driving switch 200, the switch detecting part 208 emits a high-level signal (sounding start signal). When not detecting the operation of the driving switch 200, the switch detecting part 208 emits a low-level signal.

In case the sounding start signal is input, the sound generating circuit 209 generates a predetermined acoustic signal and outputs the acoustic signal as a digital signal (third electric signal). The sound generating circuit 209 has sound data previously stored therein data for generating multiple types of acoustic signals. The user may arbitrarily select the type of acoustic signal. As the sound data, a voice signal and various types of effect sound signals are available. In this embodiment, it is assumed that sound data to represent an effect sound has been pre-selected.

The D/A converter 205 converts the digital signal of the effect sound to an analog signal. The amplifier 206 amplifies the analog signal of the effect sound and supplies the resulting signal to the speaker 207. The speaker 207 converts the amplified analog signal to a sound and emits an effect sound.

As mentioned earlier, a plurality of switches (not shown) may be provided in correspondence to respective controllers such as direction signals and a reverse gear. In such a case, a plurality of switch detecting parts are provided in one-to-one correspondence to each switch (not shown). Each of the respective switch detecting parts outputs a sounding start signal corresponding to the operated switch.

In case a sounding start signal corresponding to each switch is input, the sound generating circuit 209 generates an associated voice signal and outputs the voice signal as a digital signal. For example, when the user has selected a reverse gear, a sounding start signal for reversing is input with the voice signal “reversing”. When a left turn is made with a direction signal operated, a sounding start for left turn is input with the voice signal “making a left turn”.

In this case, a selector (not shown) is provided between the amplifier 206 and a plurality of speakers (not shown) or in the sound generating circuit 209. The selector inputs a sounding start signal corresponding to one of the plural switches and selects a signal path in one-to-one correspondence to the sounding start signal from among the plurality of signal paths. That is, the selector uses an arbitrary speaker selected from among the plurality of speakers and causes it to emit a sound. The plurality of speakers are arranged in the travel direction of a vehicle in accordance with the corresponding operation. For example, a speaker corresponding to reversing is arranged in the rear of the vehicle while a speaker corresponding to a left turn is arranged on the left side of the vehicle.

A series of voice emission will be described. In case the user has selected a reverse gear, a reverse gear switch is turned on. Detecting this operation, a reverse gear switch detecting part outputs a sounding start signal. The sound generating circuit 209, on input of the sounding start signal, generates the voice signal “reversing” and outputs the voice signal as a digital signal (third electric signal).

The D/A converter 205 converts the digital signal of the voice to an analog signal. The amplifier 206 amplifies the analog signal of the voice and inputs the resulting signal to the selector. The selector also inputs the sounding start signal as a control signal and uses the signal to select a signal path to a speaker arranged in the rear of the automobile and supplies the amplified analog signal. The speaker arranged in the rear of the automobile converts the amplified analog signal to a sound and emits the voice “reversing” in the backward direction.

A volume may be provided in place of a selector and the sounding volume of each of the speakers may be adjusted.

Through the tone quality processing and voice generation described above, a very small operation noise from the mechanism part 201 of the vehicle and other small running noise as well as a sound obtained by acoustic signal processing of a sound from a motor or a mechanism part and an effect sound synthesized by the sound generating circuit 209 are amplified and emitted from the speaker 207 into the surroundings. A pedestrian around hears the three types of sounds as a natural, inoffensive running noise. It is thus possible to notify the people around of the approach of a vehicle with vary small running noise.

A natural noise of a vehicle is generated and emitted. This represents the noise inherent to the vehicle and allows a pedestrian around to intuitively acquire the information on the travel of the vehicle such as the vehicle type and speed. In other words, this vehicle-mounted sounding device allows an appropriate running noise corresponding to a particular vehicle type and speed to be formed and emitted.

Moreover, the sound generating circuit 209 generates a voice so as to notify a pedestrian in the travel direction of a vehicle of a right/left turn or reversing to alert the pedestrian. This approach, in combination with processing of a running noise, will improve the safety.

The two types of abnormal state monitoring takes place in parallel with the tone quality processing and voice generation.

(3) Abnormal State Monitoring 1

The sound pressure detector 210 constantly monitors the digital signal as the output of the A/D converter 203 and detects a sound pressure of an operation noise at a predetermined level or above input to the microphone 202. To be more precise, the sound pressure detector 210 outputs a high-level signal in case it has detected a sound pressure at a predetermined level or above while it outputs a low-level signal in case it has detected a sound pressure below a predetermined level. The output of the sound pressure detector 210 and the output of the switch detecting part 208 are respectively input to the comparator 211. The comparator 211 is configured by an exclusive OR circuit.

Assume that an abnormal state (a fault) has occurred where a sound pressure of an operation noise at a predetermined level or above is not detected due to a fault in the mechanism part 201 or microphone 202 although the driving switch 200 is operated. In such a case, the output signal of the sound pressure detector 210 is driven Low while the output signal of the switch detecting part 208 is driven High.

Assume that an abnormal state (a fault) has occurred where a sound pressure of an operation noise at a predetermined level or above is detected due to a fault in the mechanism part 201 or microphone 202 although the driving switch 200 is not operated. In such a case, the output signal of the sound pressure detector 210 is driven High while the output signal of the switch detecting part 208 is driven Low since the driving switch 200 is not operated.

Thus, under the two conditions, the output signal of the comparator 211 is driven High (a signal indicating an abnormal state). Receiving this signal, the abnormal state detecting part 212 detects an abnormal state and outputs an abnormal state detecting signal to the sound generating circuit 209. Using the abnormal state detecting signal as a trigger, the sound generating circuit 209 generates a warning sound signal (third electric signal) for reporting an abnormal state (fault) and emits a warning sound from the speaker 207 thus notifying the user of the abnormal state in the device.

In normal operation, the output signal of the switch detecting part 208 has the same level as the output signal of the sound pressure detector 210. This drives the output signal of the comparator 211 low and the abnormal state detecting part 212 that receives this signal does not output an abnormal state detecting signal to the sound generating circuit 209.

(4) Abnormal State Monitoring 2

The speed detecting part 213 detects the travel speed of an automobile from a speedometer (not shown) and detects a speed at a predetermined level or above. To be more precise, the speed detecting part 213 outputs a high-level signal in case it has detected a speed at a predetermined level or above while it outputs a low-level signal in case it has detected a speed below a predetermined level. The output of the speed detecting part 213 and the output of the sound pressure detector 210 are respectively input to the comparator 214. The comparator 214 is configured by an exclusive OR circuit.

Assume that an abnormal state (a fault) has occurred where a sound pressure of an operation noise at a predetermined level or above is not detected due to a fault in the microphone 202 although the speed is at a predetermined level or above. In such a case, the output signal of the sound pressure detector 210 is driven Low while the output signal of the speed detecting part 213 is driven High.

Assume that an abnormal state (a fault) has occurred where a sound pressure of an operation noise at a predetermined level or above is not detected due to a fault in a speedometer although the speed is at a predetermined level or above. In such a case, the output signal of the speed detecting part 213 is driven Low while the output signal of the sound pressure detector 210 is driven High since an operation noise is detected.

Thus, under the two conditions, the output signal of the comparator 214 is driven High (a signal indicating an abnormal state). Receiving this signal, the abnormal state detecting part 215 outputs an abnormal state detecting signal to the sound generating circuit 209. Using the abnormal state detecting signal as a trigger, the sound generating circuit 209 generates a warning sound signal (third electric signal) for reporting an abnormal state (fault) and emits a warning sound from the speaker 207 thus notifying the user of the abnormal state in the device.

In normal operation, the output signal of the speed detecting part 213 has the same level as the output signal of the sound pressure detector 210. This drives the output signal of the comparator 214 Low and the abnormal state detecting part 215 that receives this signal does not output an abnormal state detecting signal to the sound generating circuit 209.

The Low or High level of a signal defined in this embodiment is not limiting but the signal levels may be exchanged as long as a similar function is provided.

According to the invention, it is possible to change the running noise emitted into the surroundings only by adding the vehicle-mounted sounding device without modifying an existing automobile system. It is also possible to emit a running noise of a natural tone quality at an appropriate volume. Further, it is possible to provide the vehicle-mounted sounding device at a low cost.

While the embodiments of the invention have been detailed, a specific configuration is not limited to the embodiments but may include a design change that is within the scope and spirit of the invention.

The invention is preferably used for a vehicle-mounted sounding device that emits a warning sound of a vehicle.

What is claimed is:

1. A vehicle-mounted sounding device comprising:
a sound collector that collects a sound emitted by a vehicle and converts the sound to a first electric signal;
a signal processor that applies acoustic signal processing to the first electric signal and outputs a second electric signal; and
a sound emitter that inputs the second electric signal and emits a sound based on the second electric signal.

2. The vehicle-mounted sounding device according to claim 1 further comprising:
a switch operation detector that detects switch operation related to a horn of a vehicle; and
a sound generator that generates a third electric signal for sounding and outputs the third electric signal to the sound emitter when the switch operation detector detects the switch operation,
wherein the sound emitter inputs the third electric signal and emits a sound based on the third electric signal.

3. The vehicle-mounted sounding device according to claim 1 further comprising:
a switch operation detector that detects switch operation related to a traveling of a vehicle; and
sound generator that generates a third electric signal for sounding and outputs the third electric signal to the sound emitter when the switch operation detector detects the switch operation,
wherein the sound emitter inputs the third electric signal and emits a sound based on the third electric signal.

4. The vehicle-mounted sounding device according to claim 2 further comprising:
a signal intensity detector that detects intensity of the first electric signal; and
an abnormal state detector that detects an abnormal state based on the detection result of the switch operation detector and the detection result of the signal intensity detector,
wherein the sound generator outputs as the third electric signal an electric signal that represents a warning sound when the abnormal state detector detects the abnormal state.

5. The vehicle-mounted sounding device according to claim 3 further comprising:
a signal intensity detector that detects intensity of the first electric signal;
a speed detector that detects a traveling speed of the vehicle;
a first abnormal state detector that detects an abnormal state based on the detection result of the switch operation detector and the detection result of the signal intensity detector; and
a second abnormal state detector that detects an abnormal state based on the detection result of the speed detector and the detection result of the signal intensity detector,
wherein the sound generator outputs as the third electric signal an electric signal that represents a warning sound when the first abnormal state detector or the second abnormal state detector detects the abnormal state.

6. The vehicle-mounted sounding device according to claim 1, wherein
the sound generator comprises an amplifier for amplifying the third electric signal and a plurality of speakers driven by the amplifier, and
the amplifier selectively drives a specific speaker corresponding to a travel direction of a vehicle.
